(19) United States
(12) Patent Application Publication
(10) Pub. No.: US 2026/0138925 A1
(43) Pub. Date: May 21, 2026

(54) LEAD-ZINC TAILINGS-BASED CERAMSITE

(71) Applicant: Henan Building Materials Research and Design Institute Co., Ltd, Zhengzhou (CN)

(72) Inventors: Maoliang Zhang, Zhengzhou (CN); Xindi Wan, Zhengzhou (CN); Yan Ma, Zhengzhou (CN); Jianwei Li, Zhengzhou (CN); Jinhua Wang, Zhengzhou (CN); Lu Zhang, Zhengzhou (CN); Huanhuan Zhang, Zhengzhou (CN); Huiling Yin, Zhengzhou (CN)

(21) Appl. No.: 19/390,419

(22) Filed: Nov. 14, 2025

(30) Foreign Application Priority Data
Nov. 18, 2024 (CN) 202411642746.2

(51) Int. Cl. C04B 33/138; C04B 33/32

(52) U.S. Cl. CPC C04B 33/138; C04B 33/32

(57) ABSTRACT

A lead-zinc tailings-based ceramsite includes the following raw materials in parts by mass: 100 parts of lead-zinc tailings; 20-30 parts of limestone tailings; 6-8 parts of activated mullite nanopowder, 1-3 parts of glass powder, and 8-12 parts of dried sludge powder. A preparation method for the lead-zinc tailings-based ceramsite is further provided.

### CROSS-REFERENCE TO RELATED APPLICATION

This application claims priority of Chinese Patent Application No. 202411642746.2, filed on Nov. 18, 2024, the entire contents of which are incorporated herein by reference.

### TECHNICAL FIELD

The present disclosure belongs to the technical field of resource recycling, and specifically relates to a lead-zinc tailings-based ceramsite.

### BACKGROUND

Lead-zinc tailings are low-grade ore residues left after the flotation process extracts concentrate ore during mining operations by lead-zinc enterprises, mostly existing as a slurry mixed with sand and gravel. Currently, related enterprises generate over 20 million tons of lead-zinc tailings annually, with stockpile volumes continuing to rise. The accumulation of lead-zinc tailings and smelting slag can lead to the dispersion of heavy metals. Under prolonged storage, these materials are affected by a combination of internal and external factors, resulting in hazardous substances such as heavy metal liquid (e.g., in the form of acidic water) being leached out. These hazardous substances are transported by rainwater scouring and other pathways into surface rivers and groundwater systems, thereby causing severe heavy metal contamination of water resources both within and beyond mining areas. Therefore, resource utilization of lead-zinc tailings is of critical importance.

Currently, lead-zinc tailings are utilized as raw materials in the production of cement, building wall materials, ceramsite, ceramics, glass, unfired wall bricks, and artificial marble. Moreover, due to the similarity in composition between lead-zinc tailings and clay, the lead-zinc tailings can be used as a clay substitute in ingredients to produce cement that complies with national standards. However, due to the substantial stockpiles and high heavy metal content of lead-zinc tailings, the immobilization of these heavy metals during resource utilization represents a critical priority. Consequently, ceramsite, as an important technical method for heavy metal immobilization, has been applied in the treatment of lead-zinc tailings. Therefore, utilizing lead-zinc tailings as raw materials for lightweight aggregate production can advance the technological progress in reducing, recycling, and treating these tailings in a harmless manner, thereby promoting sustainable development within the lead-zinc tailings industry.

### SUMMARY

To solve the problems in the related art, the present disclosure provides a lead-zinc tailings-based ceramsite.

To realize the above objective, the present disclosure employs the following technical solution:

the lead-zinc tailings-based ceramsite includes the following raw materials in parts by mass:
100 parts of lead-zinc tailings;
20-30 parts of limestone tailings;
6-8 parts of activated mullite nanopowder;
1-3 parts of glass powder; and
8-12 parts of dried sludge powder.

The activated mullite nanopowder is produced by uniformly dispersing mullite particles in a mixed solution of sodium silicate and potassium silicate, followed by heating and grinding.

A mass ratio of the mullite particles to the sodium silicate and the potassium silicate is 1:(1-2):(3-5); when the activated mullite nanopowder is produced, a target temperature is 300-600° C.; and the activated mullite nanopowder has a particle size of 200-400 nm.

The target temperature of 300-600° C. is selected because within this range, sodium silicate and potassium silicate lose bound water and gel property, thereby facilitating grinding, whereas excessively low temperatures make grinding difficult.

The particle size of the activated mullite nanopowder is controlled within the range of 200-400 nm because this specific size range can achieve effective coating of mullite nanoparticles by sodium silicate/potassium silicate, while ensuring structural integrity and activation effectiveness of the mullite nanoparticles.

The mullite particles have a particle size of 50-100 nm; the mixed solution of sodium silicate and potassium silicate has a concentration of 5-15 wt %; and both sodium silicate and potassium silicate have a modulus not exceeding 2.

The modulus of sodium silicate and the modulus of potassium silicate are both controlled to be no greater than 2 because an excessively high modulus results in significantly increased viscosity, which leads to non-uniform dispersion of the mullite particles and poor effectiveness in promoting silica dissolution at high temperatures.

A specific surface area of the lead-zinc tailings is 800-1000 m²/kg because an insufficient value would hinder the dissolution of silica and alumina, failing to form a high-strength structure and consequently leading to low strength.

A specific surface area of the limestone tailings is not less than 200 m²/kg because an excessively low specific surface area would result in non-uniform distribution within the ceramsite, failing to form a continuous and stable binding structure and causing a reduction in strength.

A specific surface area of the glass powder is not less than 300 m²/kg to ensure its uniform dispersion.

A specific surface area of the dried sludge powder is not less than 200 m²/kg to ensure its homogeneous dispersion.

A preparation method for the lead-zinc tailings-based ceramsite includes the steps of:
(1) uniformly mixing the raw materials including the lead-zinc tailings, the limestone tailings, the activated mullite nanopowder, the glass powder, and the dried sludge powder in the parts by mass, and adding water to prepare a ceramsite green body;
(2) heating the ceramsite green body to temperature of 900-980° C. and maintaining the temperature for 5-8 min; and heating the ceramsite green body to temperature of 1200-1300° C. and maintaining the temperature for 8-10 min; and
(3) cooling the ceramsite green body to temperature of 1150-1100° C. and maintaining the temperature for 5-10 min; cooling the ceramsite green body to temperature of 1080-1000° C. and maintaining the temperature for 5-10 min; cooling the ceramsite green body to temperature of 950-900° C. and maintaining the temperature for 5-10 min; and slowly cooling the ceramsite green body to standard ambient temperature to obtain the lead-zinc tailings-based ceramsite.

A preparation method for the activated mullite nanopowder includes the steps of: uniformly dispersing the mullite particles in the mixed solution of sodium silicate and potassium silicate; heating and drying the mixture until dried mixture reaches a constant mass; and grinding the dried mixture under completely dry conditions to a particle size of 200-400 nm to obtain the activated mullite nanopowder.

The stepwise cooling in step (3) is implemented for hardening because direct cooling would induce disordered solidification of all molten phases, which generates numerous microcracks in the structure, compromises its structural strength, and adversely affects water absorption of the ceramsite.

During slowly cooling the ceramsite green body to standard ambient temperature in step (3), a cooling rate is not exceed 10° C./min, as an excessively high cooling rate is prone to induce crack formation.

### Beneficial Effects

(1) In the present disclosure, the method uses the lead-zinc tailings as the primary raw material to prepare the lead-zinc tailings-based ceramsite. By compounding the lead-zinc tailings with the limestone tailings, a synergistic effect between the two types of tailings is achieved, thereby ensuring resource utilization of the lead-zinc tailings and the limestone tailings and offering considerable economic and social benefits. Additionally, the ceramsite prepared by the present disclosure exhibits a density grade of 600 to 900, a cylinder compressive strength of 6.8 to 9.8 MPa, and a water absorption rate of 9.4% to 11.4%, thereby achieving favorable strength characteristics and a relatively low water absorption rate.

(2) In the present disclosure, the mullite particles are activated and modified using sodium silicate and potassium silicate to prepare the activated mullite nanopowder, enhancing a leaching rate and a leaching amount of active substances in the lead-zinc tailings, thereby improving the overall performance of the lead-zinc tailings-based ceramsite. The activated mullite nanopowder serves as crystalline seeds, effectively promoting the formation of mullite crystals from the lead-zinc tailings-based ceramsite at high temperatures and thereby enhancing the bonding strength between inert particles within the ceramsite.

(3) In the present disclosure, the sludge powder and the glass powder are utilized to provide sufficient molten silica, which facilitates the retention of gas bubbles in a molten glass matrix, thereby increasing the porosity of the ceramsite. Sludge can provide organic matter that generates gases at high temperatures, facilitating the formation of a porous structure in the ceramsite. Unlike limestone, pores in the sludge are created through combustion of its organic matter at relatively lower temperatures, leaving behind a porous structure after the combustion of the organic matter. In contrast, the limestone can produce gases that become trapped within the molten liquid formed by the melted glass powder, resulting in the formation of bubbles.

(4) In the present disclosure, gases are generated through the combustion of the organic matter in the sludge powder, while carbon dioxide gas is released by thermal decomposition of calcium carbonate in the limestone tailings at high temperatures, whereby the porosity of the ceramsite is enhanced. Simultaneously, calcium oxide resulting from the decomposition is reacted with silica at high temperatures to form calcium silicate, by which the lead-zinc tailings particles are encapsulated and bonded, thereby improving the strength of the ceramsite.

### DETAILED DESCRIPTION

The present disclosure is further described in detail below in combination with specific embodiments.

### Embodiment 1

A lead-zinc tailings-based ceramsite includes the following raw materials in parts by mass:
100 parts of lead-zinc tailings;
20 parts of limestone tailings;
6 parts of activated mullite nanopowder;
3 parts of glass powder; and
8 parts of dried sludge powder.

A specific surface area of the lead-zinc tailings is 1000 m²/kg, a specific surface area of the limestone tailings is 200 m²/kg, and a specific surface area of the glass powder is 300 m²/kg.

A preparation method for the activated mullite nanopowder included the steps that: mullite particles having a particle size of 80 nm were uniformly dispersed in a concentration of 5 wt % mixed solution of sodium silicate and potassium silicate; the mixture was heated to 300° C. (target temperature) and dried until dried mixture reached a constant mass; and the dried mixture was ground under completely dry conditions to a particle size of 300 nm, and in the mixture, a mass ratio of the mullite particles to the sodium silicate and the potassium silicate was 1:2:5.

The sodium silicate has a modulus of 2.0, and the potassium silicate has a modulus of 1.0.

The dried sludge powder is obtained by drying and grinding sludge to powder with a specific surface area of 200 m²/kg.

A preparation method for the lead-zinc tailings-based ceramsite included the steps that: in step (1), the above raw materials were uniformly mixed, and 50 parts of water were added to prepare a ceramsite green body using a granulator. In step (2), the ceramsite green body was heated to temperature of 980° C. and maintained for 5 min, and was heated to temperature of 1300° C. and maintained for 8 min. In step (3), the ceramsite green body was cooled to temperature of 1120° C. and maintained for 7 min; was cooled to temperature of 1050° C. and maintained for 7 min; was cooled to temperature of 920° C. and maintained for 7 min; and the ceramsite green body was slowly cooled to standard ambient temperature (20° C.-25° C.) at a cooling rate of 5° C./min, to obtain the lead-zinc tailings-based ceramsite.

### Embodiment 2

A lead-zinc tailings-based ceramsite includes the following raw materials in parts by mass:
100 parts of lead-zinc tailings;
30 parts of limestone tailings;
8 parts of activated mullite nanopowder;
1 part of glass powder; and
12 parts of dried sludge powder.

A specific surface area of the lead-zinc tailings is 800 m²/kg, a specific surface area of the limestone tailings is 300 m²/kg, and a specific surface area of the glass powder is 400 m²/kg.

A preparation method for the activated mullite nanopowder included the steps that: mullite particles having a particle size of 100 nm were uniformly dispersed in a concentration of 15 wt % mixed solution of sodium silicate and potassium silicate; the mixture was heated to 600° C. (target temperature) and dried until dried mixture reached a constant mass; and the dried mixture was ground under completely dry conditions to a particle size of 400 nm, and in the mixture, a mass ratio of the mullite particles to the sodium silicate and the potassium silicate was 1:1:3.

The sodium silicate has a modulus of 1.0, and the potassium silicate has a modulus of 1.0.

The dried sludge powder is obtained by drying and grinding sludge to powder with a specific surface area of 300 m²/kg.

A preparation method for the lead-zinc tailings-based ceramsite included the steps that: in step (1), the above raw materials were uniformly mixed, and 40 parts of water were added to prepare a ceramsite green body using a granulator. In step (2), the ceramsite green body was heated to temperature of 900° C. and maintained for 8 min, and was heated to temperature of 1200° C. and maintained for 10 min. In step (3), the ceramsite green body was cooled to temperature of 1150° C. and maintained for 5 min; was cooled to temperature of 1080° C. and maintained for 5 min; was cooled to temperature of 950c and maintained for 5 min; and the ceramsite green body was slowly cooled to standard ambient temperature (20° C.-25° C.) at a cooling rate of 10° C./min, to obtain the lead-zinc tailings-based ceramsite.

### Embodiment 3

A lead-zinc tailings-based ceramsite includes the following raw materials in parts by mass:
100 parts of lead-zinc tailings;
25 parts of limestone tailings;
7 parts of activated mullite nanopowder;
2 parts of glass powder; and
10 parts of dried sludge powder.

A specific surface area of the lead-zinc tailings is 900 m²/kg, a specific surface area of the limestone tailings is 400 m²/kg, a specific surface area of the glass powder is 450 m²/kg.

A preparation method for the activated mullite nanopowder included the steps that: mullite particles having a particle size of 50 nm were uniformly dispersed in a concentration of 10 wt % mixed solution of sodium silicate and potassium silicate; the mixture was heated to 400° C. (target temperature) and dried until dried mixture reached a constant mass; and the dried mixture was ground under completely dry conditions to a particle size of 200 nm, and in the mixture, a mass ratio of the mullite particles to the sodium silicate and the potassium silicate is 1:1.5:4.

The sodium silicate has a modulus of 1.5, and the potassium silicate has a modulus of 1.5.

The dried sludge powder is obtained by drying and grinding sludge to powder with a specific surface area of 350 m²/kg.

A preparation method for the lead-zinc tailings-based ceramsite included the steps that: in step (1), the above raw materials were uniformly mixed, and 48 parts of water were added to prepare a ceramsite green body using a granulator. In step (2), the ceramsite green body was heated to temperature of 950° C. and maintained for 6 min, and was heated to temperature of 1250° C. and maintained for 9 min. In step (3), the ceramsite green body was cooled to temperature of 1100° C. and maintained for 10 min; was cooled to temperature of 1000° C. and maintained for 10 min; was cooled to temperature of 900° C. and maintained for 10 min; and the ceramsite green body was slowly cooled to standard ambient temperature (20° C.-25° C.) at a cooling rate of 3° C./min, to obtain the lead-zinc tailings-based ceramsite.

The properties of the ceramsites from Embodiments 1-3 are tested in accordance with the Chinese National Standard GB/T 17431.1-2010 “Lightweight aggregates and test methods thereof-Part 1: Lightweight aggregates”, with results presented in Table 1.

TABLE 1
Properties of ceramsites from Embodiments 1-3

| | Density | Cylinder compressive | Water absorption |
|---|---|---|---|
| Serial number | grade | strength (MPa) | rate (%) |
| Embodiment 1 | 900 | 9.8 | 9.8 |
| Embodiment 2 | 600 | 6.8 | 11.4 |
| Embodiment 3 | 800 | 8.2 | 9.4 |

As shown in Table 1, the ceramsites from Embodiments 1-3 exhibit a density grade of 600 to 900, a cylinder compressive strength of 6.8 to 9.8 MPa, and a water absorption rate of 9.4% to 11.4%. These results demonstrate that the present disclosure achieves favorable cylinder compressive strength and relatively low water absorption, facilitating high-quality preparation of lead-zinc tailings-based ceramsite. As can be seen from variations in density grade and cylinder compressive strength, the differences are primarily attributed to dried sludge powder content. A higher content of dried sludge powder corresponds to a greater amount of organic matter, which generates an increased volume of gases at high temperatures, thereby causing a reduction in cylinder compressive strength and an increase in water absorption rate of the ceramsite. Nevertheless, under the controlled content of dried sludge powder according to the present disclosure, the lead-zinc tailings-based ceramsite achieves favorable mechanical properties and water absorption rate.

### Comparative Embodiment 1

This comparative embodiment differs from Embodiment 3 in that the specific surface area of the lead-zinc tailings is 600 m²/kg.

### Comparative Embodiment 2

This comparative embodiment differs from Embodiment 3 in that the specific surface area of the lead-zinc tailings is 1200 m²/kg.

The properties of the ceramsites from Comparative Embodiments 1-2 are tested, with results presented in Table 2.

TABLE 2
Properties of ceramsites from Comparative Embodiments 1-2

| | Specific | | | |
|---|---|---|---|---|
| | surface area | | | |
| | of the | | Cylinder | |
| | lead-zinc | | compressive | Water |
| | tailings | Density | strength | absorption |
| Serial number | (m²/kg) | grade | (MPa) | rate (%) |
| Embodiment 3 | 900 | 800 | 8.2 | 9.4 |
| Comparative | 600 | 800 | 5.1 | 16.8 |
| Embodiment 1 | | | | |
| Comparative | 1200 | 800 | 6.4 | 18.4 |
| Embodiment 2 | | | | |

As can be seen from a comparison between Comparative Embodiments 1-2 and Embodiment 3 in Table 2, lead-zinc tailings with a larger specific surface area demonstrate reduced cylinder compressive strength and elevated water absorption rate. This phenomenon is primarily attributed to the presence of a substantial amount of inert particles in the lead-zinc tailings. Excessively small particle size can cause increased shrinkage, promote microcrack formation, and compromise structural stability, collectively resulting in diminished strength and elevated water absorption rate. The lead-zinc tailings with a smaller specific surface area exhibit reduced cylinder compressive strength and increased water absorption rate. When the specific surface area is smaller, the formation of molten glass matrix is reduced, making melting difficult and resulting in lower bonding strength, which consequently leads to reduced cylinder compressive strength. Therefore, lead-zinc tailings with an appropriately selected specific surface area can yield ceramsite with optimized performance.

### Comparative Embodiment 3

This comparative embodiment differs from Embodiment 3 in that no limestone tailings are added.

### Comparative Embodiment 4

This comparative embodiment differs from Embodiment 3 in that the amount of limestone tailings added is 10 parts.

### Comparative Embodiment 5

This comparative embodiment differs from Embodiment 3 in that the amount of limestone tailings added is 40 parts.

The properties of the ceramsites from Comparative Embodiments 3-5 are tested, with results presented in Table 3.

TABLE 3
Properties of ceramsites from Comparative Embodiments 3-5

| | Limestone | | Cylinder | |
|---|---|---|---|---|
| | tailings | Density | compressive | Water absorption |
| Serial number | (parts) | grade | strength (MPa) | rate (%) |
| Embodiment 3 | 25 | 800 | 8.2 | 9.4 |
| Comparative | 0 | 800 | 4.3 | 23.5 |
| Embodiment 3 | | | | |
| Comparative | 10 | 800 | 5.3 | 14.7 |
| Embodiment 4 | | | | |
| Comparative | 40 | 800 | 5.6 | 13.8 |
| Embodiment 5 | | | | |

As demonstrated by the comparison of Comparative Embodiments 3-5 with Embodiment 3 in Table 3, as an addition amount of limestone tailings increases, the strength of the lead-zinc tailings-based ceramsite initially rises and subsequently falls, while the water absorption rate initially falls and subsequently rises, with Embodiment 3 exhibiting optimal performance. This result is primarily attributed to calcium carbonate provided by the limestone tailings, which decomposes at high temperatures to generate gases, thereby contributing to a porous structure in the ceramsite and a consequent reduction in strength. Calcium carbonate is decomposed to release carbon dioxide within a temperature range of 900-980° C., thereby forming calcium oxide. At the same time, during calcination at 1200-1300° C., the resulting calcium oxide is reacted with molten silica to form calcium silicate. Following this, the calcium silicate is hardened into a gel-like binding structure through slow cooling. Under these conditions, the silica is consumed due to the formation of calcium silicate. Through the fluxing action of potassium silicate and sodium silicate, additional silica is dissolved from the lead-zinc tailings. Consequently, the bonding strength of the glass matrix in the ceramsite is enhanced, and the water absorption is reduced. Therefore, the addition of limestone exhibits a dual effect on both mechanical properties and water absorption rate of the ceramsite. When the addition amount of limestone is low, as its addition amount increases, gas produced at high temperatures increases, thereby increasing porosity in the ceramsite structure and reducing strength. However, the formation of calcium silicate at 1200-1300° C. enhances structural strength, fully compensating for the strength reduction caused by increased gas generation. Under conditions of low gas content, the pores formed are predominantly closed. Consequently, water absorption rate does not increase. In contrast, the structural densification attributable to the calcium silicate serves to decrease the water absorption rate. However, when the addition amount is excessively high, excessive gas generation leads to an increase in the negative effect of too many pores. The resulting calcium silicate cannot compensate for the strength reduction caused by increased gas generation, thereby reducing the ceramsite strength and increasing water absorption rate. Moreover, interconnected pores are formed due to the surplus gas, thereby increasing the water absorption rate. Therefore, limestone tailings with an appropriately selected addition amount can yield ceramsite with optimized performance.

### Comparative Embodiment 6

This comparative embodiment differs from Embodiment 3 in that a particle size of mullite is 200 nm.

The properties of the ceramsite from Comparative Embodiment 6 are tested, with results presented in Table 4.

TABLE 4
Properties of ceramsite from Comparative Embodiment 6

| | Particle | | Cylinder | |
|---|---|---|---|---|
| | size of | | compressive | Water |
| | mullite | Density | strength | absorption |
| Serial number | (nm) | grade | (MPa) | rate (%) |
| Embodiment 3 | 50 | 800 | 8.2 | 9.4 |
| Comparative | 200 | 800 | 6.4 | 17.9 |
| Embodiment 6 | | | | |

As evidenced by the comparison between Comparative Embodiment 6 and Embodiment 3 in Table 4, Comparative Embodiment 6 exhibits reduced cylinder compressive strength and increased water absorption rate. This confirms that mullite nanopowder acts as a seed crystal. When the particle size of these seeds increases, the nucleation efficiency diminishes, resulting in less mullite being formed during high temperatures. Mullite primarily serves to bond particles and enhance strength. A reduction in the formation of mullite consequently leads to diminished strength and an elevated water absorption rate.

### Comparative Embodiment 7

This comparative embodiment differs from Embodiment 3 in that only sodium silicate is employed in the preparation of activated mullite nanopowder, and the process omits the step of cooling the body to temperature of 900° C. and maintaining the temperature for 10 min in step (3).

### Comparative Embodiment 8

This comparative embodiment differs from Embodiment 3 in that only potassium silicate is employed in the preparation of activated mullite nanopowder, and the process omits the step of cooling the body to temperature of 1000° C. and maintaining the temperature for 10 min in step (3).

The properties of the ceramsites from Comparative Embodiments 7-8 are tested, with results presented in Table 5.

TABLE 5
Properties of ceramsites from Comparative Embodiments 7-8

| | Modification | | Cylinder | |
|---|---|---|---|---|
| | and activation | | compressive | Water |
| | of mullite | Density | strength | absorption |
| Serial number | nanopowder | grade | (MPa) | rate (%) |
| Embodiment 3 | Sodium silicate and | 800 | 8.2 | 9.4 |
| | potassium silicate | | | |
| Comparative | Sodium silicate | 800 | 6.2 | 16.5 |
| Embodiment 7 | | | | |
| Comparative | Potassium silicate | 800 | 6.1 | 16.0 |
| Embodiment 8 | | | | |

As demonstrated by the comparison of Comparative Embodiments 7-8 with Embodiment 3 in Table 5, the sole use of either sodium silicate or potassium silicate for modification and activation of mullite nanopowder results in reduced cylinder compressive strength and increased water absorption rate. This indicates that the combined use of both sodium silicate and potassium silicate enhances the temperature gradient of glass matrix dissolution during the reaction process, promoting structural stability and exhibiting superior dissolution-promoting effects compared to the sole use.

### Comparative Embodiment 9

This comparative embodiment differs from Embodiment 3 in that the activated mullite nanopowder is ground to a particle size of 100 nm.

The properties of the ceramsite from Comparative Embodiment 9 are tested, with results presented in Table 6.

TABLE 6
Properties of ceramsite from Comparative Embodiment 9

| | Particle | | | |
|---|---|---|---|---|
| | size of | | | |
| | activated | | Cylinder | |
| | mullite | | compressive | Water |
| | nanopowder | Density | strength | absorption |
| Serial number | (nm) | grade | (MPa) | rate (%) |
| Embodiment 3 | 200 | 800 | 8.2 | 9.4 |
| Comparative | 100 | 800 | 5.2 | 19.1 |
| Embodiment 9 | | | | |

As shown in Table 6 by comparing Comparative Embodiment 9 with Embodiment 3, grinding activated mullite nanopowder to 100 nm is counterproductive, resulting in lower strength and higher water absorption rate. This occurs because the purpose of the activated mullite powder is to form a composite structure by integrating the mullite nanopowder with sodium silicate and potassium silicate. The alkaline nature of these silicates can lower the formation temperature of mullite nanopowder, thereby promoting the generation of mullite. Under high-temperature conditions, when the fluxing action of sodium/potassium silicate occurs, the molten silica and alumina are rapidly reacted to form a mullite structure in the presence of mullite seed crystals, thereby enhancing the structural strength of the ceramsite. Excessive grinding can compromise the composite structure formed between the mullite powder and sodium/potassium silicate, causing segregation of the mullite powder and sodium/potassium silicate and thereby preventing the mullite nanopowder from playing a good promoting role.

### Comparative Embodiment 10

This comparative embodiment differs from Embodiment 3 in that the modulus of sodium silicate and the modulus of potassium silicate in the activated mullite nanopowder are both 3.0.

The properties of the ceramsite from Comparative Embodiment 10 are tested, with results presented in Table 7.

TABLE 7
Properties of ceramsite from Comparative Embodiment 10

| | Modulus | | | |
|---|---|---|---|---|
| | of sodium | | Cylinder | |
| | silicate and | | compressive | Water |
| | potassium | Density | strength | absorption |
| Serial number | silicate | grade | (MPa) | rate (%) |
| Embodiment 3 | 1.5 | 800 | 8.2 | 9.4 |
| Comparative | 3 | 800 | 6.7 | 18.7 |
| Embodiment 10 | | | | |

As evidenced by the comparison between Comparative Embodiment 10 and Embodiment 3 in Table 7, Comparative Embodiment 10 exhibits a decrease in cylinder compressive strength and an increase in water absorption rate. This is because the modulus of sodium silicate and the modulus of potassium silicate are excessively high, resulting in elevated viscosity and non-uniform dispersion, which subsequently impairs the fluxing action and leads to reduced strength.

### Comparative Embodiment 11

This comparative embodiment differs from Embodiment 3 in that the final slow cooling step to standard ambient temperature in step (3) is conducted at a cooling rate of 20° C./min.

### Comparative Embodiment 12

This comparative embodiment differs from Embodiment 3 in that the cooling process in step (3) involved direct cooling to standard ambient temperature (without an intermediate cooling process).

The properties of the ceramsites from Comparative Embodiments 11-12 are tested, with results presented in Table 8.

TABLE 8
Properties of ceramsites from Comparative Embodiments 11-12

| | Cooling rate | Direct cooling to | | Cylinder | Water |
|---|---|---|---|---|---|
| | in step (3) | standard ambient | Density | compressive | absorption |
| Serial number | (° C./min) | temperature? | grade | strength (MPa) | rate (%) |
| Embodiment 3 | 3 | No | 800 | 8.2 | 9.4 |
| Comparative | 20 | No | 800 | 6.7 | 18.7 |
| Embodiment 11 | | | | | |
| Comparative | / | Yes | 800 | 6.0 | 15.4 |
| Embodiment 12 | | | | | |

As shown in Table 8 from the comparison of Comparative Embodiments 11-12 with Embodiment 3, an excessively rapid cooling rate in Comparative Embodiment 11 leads to reduced cylinder compressive strength and increased water absorption rate. This occurs because overly rapid cooling causes non-uniform shrinkage and lower volumetric stability, which promotes the formation of microcracks. These cracks, in turn, result in higher water absorption rate and diminished strength. In contrast, Comparative Embodiment 12 employs direct cooling to room temperature without any intermediate soaking stages, resulting in structural instability and uncontrolled shrinkage, which ultimately leads to a reduction in strength and an increase in water absorption rate.

### Comparative Embodiment 13

This comparative embodiment differs from Embodiment 3 in that the heating process involves direct heating to temperature of 1250° C.

### Comparative Embodiment 14

This comparative embodiment differs from Embodiment 3 in that a maximum heating temperature is 1180° C.

The properties of the ceramsites from Comparative Embodiments 13-14 are tested, with results presented in Table 9.

TABLE 9
Properties of ceramsites from Comparative Embodiments 13-14

| | | | | Cylinder | |
|---|---|---|---|---|---|
| | Maximum | Direct heating | | compressive | Water |
| | heating | to maximum | Density | strength | absorption |
| Serial number | temperature | temperature? | grade | (MPa) | rate (%) |
| Embodiment 3 | 1250 | No | 800 | 8.2 | 9.4 |
| Comparative | 1250 | Yes | 900 | 6.3 | 14.8 |
| Embodiment 13 | | | | | |
| Comparative | 1180 | No | 800 | 3.9 | 29.3 |
| Embodiment 14 | | | | | |

As evidenced by the comparison of Comparative Embodiments 13-14 with Embodiment 3 in Table 9, direct heating to the maximum temperature of 1250° C. in Comparative Embodiment 13 causes the dissolution of the molten glass matrix and the evolution of gas bubbles to become excessively rapid and localized, leading to vigorous bubble formation, coalescence into larger bubbles, and concomitant massive bubble escape. These defects result in a product with higher density but unexpectedly lower strength. Comparative Embodiment 14, with the maximum heating temperature of 1180° C., exhibits a significant decrease in strength and an increase in water absorption rate. This occurs because calcination within the 1200-1300° C. range facilitates the formation of calcium silicate from calcium oxide and molten silica. The resulting calcium silicate is subsequently hardened into a gel-like binding structure through a slow cooling process. Under these conditions, the silica is consumed due to the formation of calcium silicate. Through the fluxing action of potassium silicate and sodium silicate, additional silica is dissolved from the lead-zinc tailings. Consequently, the bonding strength of the glass matrix in the ceramsite is enhanced, and the water absorption rate is reduced. Conversely, when the temperature is not attained, the formation of calcium silicate is prevented, resulting in the presence of excessive calcium oxide powder in the product. Not only is the structural bonding compromised, but the calcium oxide is also highly susceptible to moisture absorption from the atmosphere, leading to hydration and expansion, which causes structural damage and significant degradation of the performance of the ceramsite.

### Comparative Embodiment 15

This comparative embodiment differs from Embodiment 3 in that the activated mullite nanopowder is excluded from the preparation of the lead-zinc tailings-based ceramsite.

### Comparative Embodiment 16

This comparative embodiment differs from Embodiment 3 in that 3 parts of activated mullite nanopowder are added.

The properties of the ceramsites from Comparative Embodiments 15-16 are tested, with results presented in Table 10.

TABLE 10
Properties of ceramsites from Comparative Embodiments 15-16

| | | | Cylinder | |
|---|---|---|---|---|
| | Activated mullite | | compressive | Water |
| | nanopowder | Density | strength | absorption |
| Serial number | (parts) | grade | (MPa) | rate (%) |
| Embodiment 3 | 7 parts | 800 | 8.2 | 9.4 |
| Comparative | 0 parts | 900 | 6.3 | 14.8 |
| Embodiment 15 | | | | |
| Comparative | 3 parts | 800 | 3.9 | 29.3 |
| Embodiment 16 | | | | |

A comparison of Comparative Embodiments 15-16 with Embodiment 3 in Table 10 shows that the omission of activated mullite nanopowder in Comparative Embodiment 15 and the addition of a reduced amount of activated mullite nanopowder in Comparative Embodiment 16 both result in a significant decrease in strength and an increase in water absorption rate. This is primarily because the activated mullite nanopowder serves as nucleation sites and a fluxing agent. When addition of the activated mullite nanopowder is insufficient, the dissolution of the glass matrix from the lead-zinc tailings is reduced. Consequently, the formation of mullite is diminished, which leads to lower compressive strength, increased porosity, and a higher water absorption rate.

### Comparative Embodiment 17

This comparative embodiment differs from Embodiment 3 in that the mullite nanopowder is added directly without activation and modification, in conjunction with both sodium silicate and potassium silicate.

### Comparative Embodiment 18

This comparative embodiment differs from Embodiment 3 in that the mullite nanopowder is directly added without activation and modification, while sodium silicate and potassium silicate are replaced with equimolar amounts of sodium oxide and potassium oxide.

The properties of the ceramsites from Comparative Embodiments 17-18 are tested, with results presented in Table 11.

TABLE 11
Properties of ceramsites from Comparative Embodiments 17-18

| | | | Cylinder | Water |
|---|---|---|---|---|
| | Added method of | Density | compressive | absorption |
| Serial number | mullite nanopowder | grade | strength (MPa) | rate (%) |
| Embodiment 3 | Activation and | 800 | 8.2 | 9.4 |
| | modification of mullite | | | |
| | with sodium silicate | | | |
| | and potassium silicate | | | |
| Comparative | Addition of sodium | 800 | 5.2 | 21.3 |
| Embodiment 17 | silicate and potassium | | | |
| | silicate without | | | |
| | activation and | | | |
| | modification of mullite | | | |
| Comparative | Addition of sodium | 800 | 4.0 | 25.2 |
| Embodiment 18 | oxide and potassium | | | |
| | oxide without | | | |
| | activation and | | | |
| | modification of mullite | | | |

As shown by the comparison of Comparative Embodiments 17-18 with Embodiment 3 in Table 11, when the mullite nanopowder is not activated and is instead added together with sodium silicate and potassium silicate directly to the ceramsite (as in Comparative Embodiment 17), a reduction in strength and an increase in water absorption rate are observed. This demonstrates that pre-mixing and activation are critical for enhancing the overall performance of the ceramsite. In Comparative Embodiment 18, potassium oxide and sodium oxide are utilized as fluxes, demonstrating a comparable fluxing effect to that of low-modulus potassium silicate and sodium silicate. However, the binding structure formed by sodium silicate and potassium silicate is not produced, thereby resulting in lower ceramsite strength and a higher water absorption rate.

1. A lead-zinc tailings-based ceramsite, comprising the following raw materials in parts by mass:
100 parts of lead-zinc tailings;
20-30 parts of limestone tailings;
6-8 parts of activated mullite nanopowder;
1-3 parts of glass powder; and
8-12 parts of dried sludge powder;
wherein the activated mullite nanopowder is produced by uniformly dispersing mullite particles in a mixed solution of sodium silicate and potassium silicate, followed by heating and grinding, with a target temperature of 300-600° C.; and
the lead-zinc tailings-based ceramsite is prepared according to following preparation method:
(1) uniformly mixing the raw materials comprising the lead-zinc tailings, the limestone tailings, the activated mullite nanopowder, the glass powder, and the dried sludge powder in parts by mass, and adding water to prepare a ceramsite green body;
(2) heating the ceramsite green body to temperature of 900-980° C. and maintaining the temperature for 5-8 min; and heating the ceramsite green body to temperature of 1200-1300° C. and maintaining the temperature for 8-10 min; and
(3) cooling the ceramsite green body to temperature of 1150-1100° C. and maintaining the temperature for 5-10 min; cooling the ceramsite green body to temperature of 1080-1000° C. and maintaining the temperature for 5-10 min; cooling the ceramsite green body to temperature of 950-900° C. and maintaining the temperature for 5-10 min; and slowly cooling the ceramsite green body to standard ambient temperature to obtain the lead-zinc tailings-based ceramsite.

2. The lead-zinc tailings-based ceramsite according to claim 1, wherein a mass ratio of the mullite particles to the sodium silicate and the potassium silicate is 1:(1-2):(3-5);
the mullite particles have a particle size of 50-100 nm; the mixed solution of sodium silicate and potassium silicate has a concentration of 5-15 wt %; and both sodium silicate and potassium silicate have a modulus not exceeding 2; and
the activated mullite nanopowder has a particle size of 200-400 nm.

3. The lead-zinc tailings-based ceramsite according to claim 1, wherein a specific surface area of the lead-zinc tailings is 800-1000 m²/kg.

4. The lead-zinc tailings-based ceramsite according to claim 1, wherein a specific surface area of the limestone tailings is not less than 200 m²/kg.

5. The lead-zinc tailings-based ceramsite according to claim 1, wherein a specific surface area of the glass powder is not less than 300 m²/kg.

6. The lead-zinc tailings-based ceramsite according to claim 1, wherein a specific surface area of the dried sludge powder is not less than 200 m²/kg.

7. The lead-zinc tailings-based ceramsite according to claim 1, wherein the activated mullite nanopowder is prepared according to following preparation method: uniformly dispersing the mullite particles in the mixed solution of sodium silicate and potassium silicate; heating and drying the mixture until dried mixture reaches a constant mass; and grinding the dried mixture under completely dry conditions to a particle size of 200-400 nm to obtain the activated mullite nanopowder.

8. The lead-zinc tailings-based ceramsite according to claim 1, wherein during slowly cooling the ceramsite green body to standard ambient temperature in step (3), a cooling rate is not exceed 10° C./min.
